(19) United States
(12) Patent Application Publication
(10) Pub. No.: US 2026/0228505 A1
(43) Pub. Date: Aug. 6, 2026

(54) AI BASED SYNTHETIC COMPUTE WORKLOAD GENERATION AND CHARACTERIZATION

(71) Applicant: HEWLETT PACKARD ENTERPRISE DEVELOPMENT LP, Spring, TX (US)

(72) Inventors: Susanta Adhikary, Bangalore (IN); Ravindhar Uppada, Bangalore (IN)

(21) Appl. No.: 19/178,577

(22) Filed: Apr. 14, 2025

(30) Foreign Application Priority Data
Feb. 5, 2025 (IN) 202541009647

(51) Int. Cl. G06N 3/0475; G06N 3/0442

(52) U.S. Cl. CPC G06N 3/0475; G06N 3/0442

(57) ABSTRACT

Systems and methods are provided for generating synthetic workload data based on real workload data using a first machine learning model. In some examples, the system may classify, using a second machine learning model, the synthetic workload data. The classification may help identify and adjust a system configuration setting of a compute device and, in some examples, retrain the second machine learning model.

### BACKGROUND

Machine learning models are typically fed a significant amount of data to generate predictions and inferences. For example, the machine learning model may be trained using an initial set of data that often covers different aspects of sensor readings and can equate to terabytes of data or more. Through this data, the machine learning model is trained through a training process. The training process can teach the model to identify features in the initial set of data and associate them to a prediction. The training process may tune weights/biases of the model in order to create the prediction.

In addition to the initial set of data, additional data may also be needed for other parts of the machine learning process. For example, data may be used for model verification and, ultimately, as input to the trained machine learning model to generate predictions (e.g., in real time).

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 is a block diagram of an example environment with synthetic compute workload generation and characterization, in accordance with implementations of the present disclosure.

FIG. 2 illustrates a synthetic compute workload generation and characterization process, in accordance with some examples described herein.

FIG. 3 illustrates a synthetic compute workload generation and characterization process, in accordance with some examples described herein.

FIG. 4 illustrates real workload data and synthetic workload data, in accordance with some examples described herein.

FIG. 5 illustrates an overlay graph of real workload data and synthetic workload data, in accordance with some examples described herein.

FIG. 6 is an example computing component that may be used to implement various features discussed herein.

FIG. 7 is a computing component that may be used to implement examples of the disclosed technology.

The figures are not exhaustive and do not limit the present disclosure to the precise form disclosed.

### DETAILED DESCRIPTION

In some dynamic computing environments, system performance is highly dependent on the effective management of resources, including task performance by GPU/CPU, memory, and I/O subsystems. However, traditional methods for tuning system configurations are often static and do not adapt to varying workload characteristics. Even when datasets are generated to create additional data and effectively train the machine learning models, the synthesized datasets fail to mimic real-world conditions that classify workloads for optimal tuning/adjustments of the system configurations. This gap hinders the development of dynamic optimization strategies that can adapt to changing workload demands in real-time, which can lead to suboptimal performance, inefficient resource usage, and increased operational costs.

Examples of the current system can generate synthetic workload data based on real workload data and classify workloads of a compute device from its combined real and synthetic workload data. “Workload data” or “real workload data” (used interchangeably) may correspond to machine-readable instruction-based computational tasks that are executed by the compute device, such that the workload data is generated when the computational task is initiated/executed (e.g., GPU- or CPU-bound, memory-bound, and I/O-bound tasks). “Synthetic workload data” may not be generated by the computational tasks initiated/executed by the compute device and have similar characteristics of the real workload data that is generated by the compute device.

The computational tasks may affect the state of the compute device (e.g., identified in workload data generated by GPU/CPU, memory, I/O, etc.). The execution and effects of the computational tasks can be detected in the workload data generated by the compute device. Diverse states of the compute device can be captured in the workload data and analyzed.

The synthetic workload data of compute device, referred to as a first compute device, may be generated by a second compute device, compute component, or server computer (used interchangeably). For example, the second compute device can use a first machine learning model, like a conditional Generative Adversarial Network (cGAN) model, to generate synthetic workload data based on real compute metrics. A second machine learning model, like Long Short-Term Memory (LSTM), can be used to help classify the real and synthetic workload data.

The current system may be implemented in multiple stages. For example, in an initial stage, the second compute device may create a large workload dataset by monitoring/receiving real workload data generated by the first compute device. The second compute device may also generate synthetic workload data to mimic the real workload data. The synthetic generation of workload data is executed using a cGAN model to include random noise and conditional input, like the real workload data may also have. The synthetic workload data generated by the cGAN model can adhere to a correlation identified in synthetically-generated workload matrices by using an external factor as input, unlike traditional GAN models that focus on broader time series properties.

In a subsequent stage, the second compute device uses the real and synthetic workload data as input to a second machine learning model, like a LSTM model, that classifies the real and synthetic workload data. The classification may help the second compute device determine the context/type of workload that is running on the compute device (e.g., based on server matrices). When the workload data are classified, the classification may correspond with a particular BIOS profile. For example, the BIOS profile may promote some tasks and/or may reduce the importance/priority of other tasks (e.g., reduce the power consumption of the compute device). The classification of the real and synthetic workload data can help identify various performance metrics at the compute device. Once performance is properly monitored and classified, the second compute device can tune/adjust configurations of the first compute device within its dynamic computing environment. These processes together can help characterize and optimize workloads at the first compute device.

In an illustrative example, the second compute device can receive first workload data of the first compute device in an initial stage. The second compute device can generate, using a first machine learning model, synthetic workload data associated with the first workload data. The synthetic workload data may be based on real device metrics, such as GPU/CPU, memory, and I/O utilization, and allow the second compute device to create a large dataset to create classification of the workload and test it. In a subsequent stage and in response to generating a threshold amount of the synthetic workload data as output from the first machine learning model, the second compute device may classify the real and synthetic workload data as a compute workload type. The classification may be generated using a second machine learning model. The second compute device may further identify and adjust a configuration setting of the first compute device based on the compute workload type. In response to receiving second workload data that is adjusted based on the system configuration setting, the second compute device can retrain the second machine learning model with the second workload data.

Technical improvements are described throughout the disclosure. For example, the configuration settings are adjusted and optimized based on a personalized assessment of the compute device. The adjustment is then analyzed and further used to adjust the training of the machine learning model, providing a continuous improvement of the configuration and operation of the compute device, as well as the machine learning model(s).

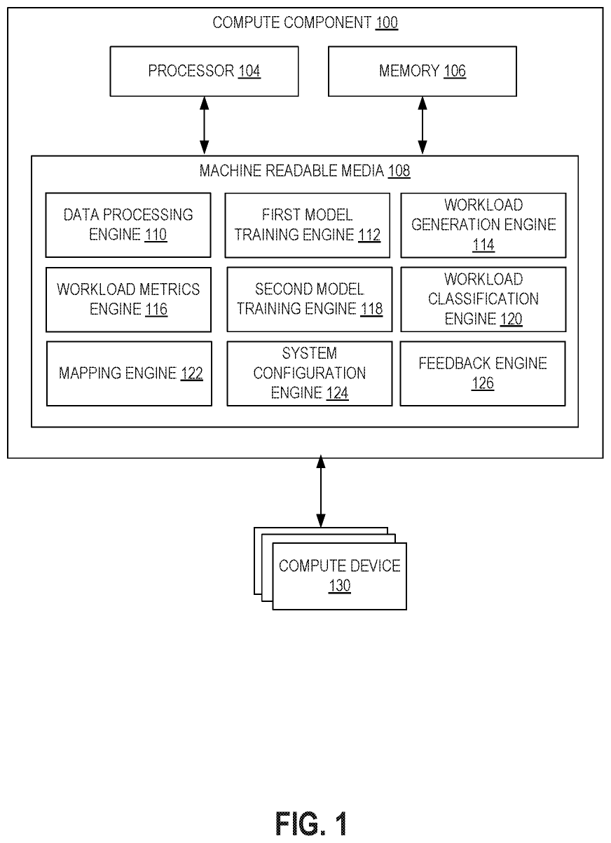

FIG. 1 is a block diagram of an example environment for AI based synthetic compute workload generation and characterization, in accordance with implementations of the present disclosure. In this example, the environment comprises compute component 100 that is communicable with (e.g., via wired or wireless communication connection) one or more compute devices 130.

Various types of environments may be implemented without diverting from the essence of the disclosure. For example, compute component 100 may be implemented as a virtual or cloud-based system that is communicable with one or more compute devices 130 that are also implemented as virtual or cloud-based devices.

Compute component 100 may be a server computer, a controller, or any other similar computing component capable of processing and transmitting data via network communications to the other devices. In the example of FIG. 1, compute component 100 comprises processor 104, memory 106, and machine readable media 108.

Processor 104 may be one or more central processing units (CPUs), semiconductor-based microprocessors, and/or other hardware devices suitable for retrieval and execution of instructions stored in machine-readable storage medium 108. Processor 104 may fetch, decode, and execute instructions to control processes or operations for implementing AI based synthetic compute workload generation and characterization. As an alternative or in addition to retrieving and executing instructions, processor 104 may include one or more electronic circuits that include electronic components for performing the functionality of one or more instructions, such as a field programmable gate array (FPGA), application specific integrated circuit (ASIC), or other electronic circuits.

Memory 106 may comprise random-access memory (RAM) or other dynamic memory for storing information and instructions to be executed by processor 104. Memory 106 might also be used for storing temporary variables or other intermediate information during execution of instructions to be executed by processor 104. Memory 106 may also comprise a read only memory (“ROM”) or other static storage device coupled to a bus for storing static information and instructions for processor 104.

Machine readable media 108 may comprise one or more interfaces, circuits, and modules for implementing the functionality discussed herein. Machine readable media 108 may carry one or more sequences of one or more instructions that can be executed by processor 104. Thus, machine-readable storage medium 108 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 108 may be a non-transitory storage medium, where the term “non-transitory” does not encompass transitory propagating signals. Such instructions embodied on machine readable media 108 may enable compute component 100 to perform features or functions of the disclosed technology as discussed herein. For example, the interfaces, circuits, and modules of machine readable media 108 may comprise, for example, data processing engine 110, first model training engine 112, workload generation engine 114, workload metrics engine 116, second model training engine 118, workload classification engine 120, mapping engine 122, system configuration engine 124, and feedback engine 126.

Data processing engine 110 may be configured to receive workload data of a compute device. The workload data may correspond with machine-readable instruction-based computational tasks that are executed/performed by the compute device. The workload data may be generated when the computational task is initiated/executed (e.g., GPU- or CPU-bound, memory-bound, and I/O-bound tasks). The computational tasks may affect the state of the compute device, which can be detected in the workload data.

The workload data may comprise operational characteristics and parameters of the compute device. For example, the workload data may comprise different types of integrations like memory bus integrations, Graphics Processing Unit (GPU) bus integrations, Central Processing Unit (CPU) bus integrations, or input/output (I/O) bus integrations. Integrations may correspond with workloads at the compute device, including memory workloads, power workloads, processor workloads, and so on.

In some examples, workload data may comprise temperature, humidity, or other sensor-detected values in an environment. The workload data may be affected by seasonality or other cyclical changes that are detectable in the workload data output generated by the compute device.

Data processing engine 110 may also be configured to pre-process the workload data. The pre-processing may clean the received workload data from the compute device. The pre-processing may remove noises, handle missing values in the workload data, standardize formatting, and the like. In some examples, the pre-processing may prepare the workload data as input to additional processing by the machine learning model(s).

First model training engine 112 may be configured with generator neural network (“generator”) and discriminator neural network (“discriminator”) that are trained to generate the synthetic workload data. The generator and discriminator networks may correspond with two neural networks that contest with each other in the form of a zero-sum game, where one agent's gain is another agent's loss. The discriminator may determine how “realistic” the generated input seems, while the generator generates the input itself, both of which are being updated dynamically. In this example, the generator may be trained to fool the discriminator, which enables the cGAN model to learn in an unsupervised manner. The generatorcan also generate candidate workload data while the discriminator evaluates it.

The contest between the generator and discriminator may operate in terms of data distributions. For example, the generator can learn to map from a latent space to a data distribution of interest, while the discriminator distinguishes candidates produced by the generator from the true data distribution. The generator's training objective may be to increase the error rate of the discriminator (i.e., “fool” the discriminator by producing novel candidates that the discriminator thinks are not synthesized and are part of the true data distribution).

In this example, the cGAN model may receive the real workload data and use it as the training dataset to learn to generate new, synthetic workload data with the same statistics as the training dataset. The generator may generate candidate synthetic workload data while the discriminator may determine how realistic the generated input seems. The generator can learn to map from a latent space to a data distribution of interest, while the discriminator distinguishes candidates produced by the generator from the true data distribution.

In some examples, the generator may be seeded with randomized input that may be sampled from a predefined latent space (e.g. a multivariate normal distribution). The candidates may be generated/synthesized by the generator and evaluated by the discriminator. Independent back-propagation procedures may be applied to both networks so that the generator produces better candidate synthetic workload data, while the discriminator learns to flag the synthetic workload data. In some examples, the generator is a de-convolutional neural network (dCNN) and the discriminator is a convolutional neural network (CNN).

First model training engine 112 may be configured to generate synthetic workload data by a cGAN model. The cGAN model may be defined as:

$$cGAN model = G ( z , X ) = Dense Layers \to Synthetic Data \\ Discriminator = D ( X , G ( z , X ) ) \\ Loss Functions = LG = - log ( D ( G ( z , X ) ) ) \\ Discriminator Loss = LD = - [ log ( D ( X ) ) + log ( 1 - D ( G ( z , X ) ) ) ]$$

As an illustrative example, a first workload may be executed at the compute device, including a CPU-bound workload. The workload data corresponding with that workload may comprise, for example, CPU classifications at 85% and memory classifications at 15%. In another example, the workload pattern may correspond to CPU classifications at 50%, memory classifications at 20%, and I/O classification at 30%. The cGAN network may generate synthetic workload data that mimics the pattern in the real workload data.

First model training engine 112 may also be configured to add random noise or conditional input, similar to the real workload data. For example, the random noise may be sampled from a vector/embedding from a simple distribution, such as a Gaussian distribution (e.g., normal distribution) or Uniform distribution. In some examples, conditional information may also be provided to the generator and discriminator in addition to the random noise. This condition may correspond with a label (e.g., workload data type or class information) or some other context that guides the generation process. The condition may be combined with the random noise in various ways, such as by concatenating it with the noise vector or by conditioning layers in the network. This conditioning can allow the generator to create specific outputs, such as generating synthetic workload data of a particular type (e.g., CPU, memory, or I/O) based on the provided label.

In some examples, the synthetic workload data may mimic interrelations between components at the compute device. For example, the interrelations of components may include processes that access the CPU, memory, and I/O for a particular workload running on the compute device. The cGAN network may generate synthetic workload data that mimics the pattern in the real workload data.

Workload generation engine 114 may be configured to combine the synthetic workload data and the real workload data. The real workload data and the synthetic workload data may be combined to form a combined workload dataset. The combined workload dataset may align with a specific pattern in the real workload data received from the compute device. Workload generation engine 114 may create a large dataset by combining the real workload data generated by the compute device with the synthetic workload data.

In some examples, workload generation engine 114 may use only synthetic workload data or only real workload data in the combined workload dataset. In either example, the combined workload dataset may align with a specific pattern in the real workload data received from the compute device. In order to use only one type of data, the amount of only one of the synthetic workload data or real workload data may exceed a threshold amount of data.

In some examples, workload generation engine 114 may include additional workload data (from data processing engine 110) to the combined workload dataset. The workload data may be generated when the computational task is initiated/executed by the compute device.

Workload metrics engine 116 may be configured to analyze workload metrics between the synthetic workload data and the real workload data. For example, workload metrics engine 116 may determine whether an amount of real workload data and synthetic workload data reaches a threshold amount (e.g., a determined value in a profile, a default value associated with the workload data, etc.). In this example, the CPU, memory, I/O, or other utilizations of the compute device identified in the real workload data may include ten days of real workload data that are aligned and illustrated in the synthetic workload data that spans more than ten days (e.g., twenty days). Although ten days of real workload data is provided as an illustrative example, the threshold amount of workload data may vary by implementation. For example, the threshold amount of data may be satisfied when patterns in the data are identified to repeat within a time period (e.g., three repeatable workload data segments). The threshold value may correspond with characteristics of the repeating patterns (e.g., power spike at 6 am, I/O workload spike every weekend, etc.) for a determined number of instances. The threshold amount of workload data may correspond with a static value. In other examples, the threshold amount of real workload data may include a duration of the workload data (e.g., one year of data). This duration of workload data may include seasonality or repeating patterns in a significant amount of real workload data. The inclusion of the repeating patterns in the real workload data may help train the first machine learning model to generate synthetic workload data with similar features throughout a reasonable duration of time. Any threshold value may be identified in examples of the system without diverting from the essence of the disclosure.

In some examples, the utilization metrics may be compared to the real workload data and the synthetic workload data. The comparison may help quantify the performance of the first machine learning model in generating the synthetic workload data to mimic the real workload data. For example, workload metrics engine 116 may use a Mean Squared Error (MSE) to quantify the performance and a low MSE value may demonstrate that the model effectively captured the underlying patterns in the real workload data. In some examples, the MSE between real workload data and the synthetic workload data may measure the difference between the two data values and quantify the average squared differences between the two datasets. For example, the MSE formula may be:

$$MSE = \frac{1}{n} {\sum }_{i = 1}^{n} {( {y}_{i} - {\hat{y}}_{i} )}^{2}$$

Where n is the total number of data points, yᵢ is the real workload data for the i-th sample, and ŷᵢ is the synthetic workload data for the i-th sample. The relatively lower MSE may indicate that the synthetic workload data is closer to the real workload data, i.e., the model's predictions are more accurate, and the relatively higher MSE may indicate a larger discrepancy between the real and synthetic values and poor model performance.

Second model training engine 118 may be configured to train a LSTM model to classify the new workload pattern in the synthetic workload data. The classification may identify a specific compute workload type or a specific pattern like CPU-bound or memory-bound. The LSTM model may classify the specific compute workload type at the compute device or set of compute devices. The classification may help the current system understand the context/type of workload that may be running on the compute (e.g., based on server matrices). For example, the LSTM model may be trained to compute the hidden states (“h_t”) and cell states (“c_t”) at each time step “t”. The Forget Gate may determine what information to discard from the cell state.

$${f}_{t} = σ ( {W}_{f} \cdot [ {h}_{t - 1} , {x}_{t} ) + {b}_{f} \\ Input Gate : Decides which values to update . \\ {i}_{t} = σ ( {W}_{i} \cdot [ {h}_{t - 1} , {x}_{t} ) + {b}_{i} \\ {C}_{t}^{∼} = tanh ( {W}_{c} \cdot [ {h}_{t - 1} , {x}_{t} ) + {b}_{C} \\ Output Gate for next hidden state : \\ {o}_{t} = σ ( {W}_{o} \cdot [ {h}_{t - 1} , {x}_{t} ) + {b}_{o} \\ {h}_{t} = {o}_{t} * tanh ( {C}_{t )}$$

After processing the entire sequence, the final output may be passed through a dense layer for classification.

The label assigned to the combined real/synthetic workload data during the classification process may correspond with the dominate workload type or characteristic. As an illustration, the workload data may be labeled “CPU-Intensive” if CPU utilization >80%, labeled “Memory-Intensive” if memory utilization >80%, labeled “I/O-Intensive” if I/O utilization >80%, and labeled “Balanced” if no utilization metric dominates. The LSTM model may classify the synthetic workload data into distinct categories.

In some examples, one LSTM model may be trained for each type of workload (e.g., a first LSTM model for CPU workloads, a second LSTM model for memory workloads, and a third LSTM model for I/O workloads). In other examples, a single LSTM model may be trained for multiple types of workloads, such that the pattern of multiple workloads may be individually classified within the trained LSTM model with the effects of each workload on the other workload types and interrelations (e.g., lower I/O workload corresponds with higher CPU workload cycles).

Workload classification engine 120 may be configured to classify the workload using the LSTM model. For example, the combined synthetic workload data and real workload data may be provided to the LSTM as input and output of the LSTM model may include a classification of a specific compute workload type identified in the workload data.

Mapping engine 122 may be configured to map the workload to a BIOS workload profile. The mapping corresponds with a particular BIOS settings, including a clock speed, CPU executions, initiated tasks that affect the power consumption, and so on. In some examples, the BIOS profile may include high performance computing.

System configuration engine 124 may be configured to identify and adjust the BIOS workload profile or system configuration setting of the compute device. For example, the change in the BIOS workload can reduce the power consumption of the device or, in some examples, adjust the execution process/mapping of the CPU. In some examples, the change in the configuration of the compute device is an adjustment to a virtualization-specific workload.

Feedback engine 126 is configured to determine the performance of the compute device by receiving/collecting additional/second real workload data after the system configuration setting is adjusted. In some examples, the LSTM model may be retrained in response to the second real workload data from the compute device. The retraining process may classify the new workload pattern in the second real workload data. In some examples, the retraining process may be continuously initiated as new workload data is received from the compute device.

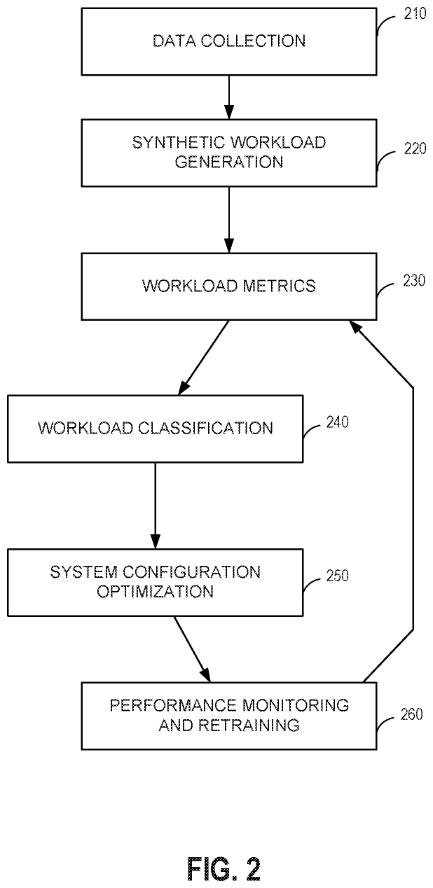

FIG. 2 illustrates a synthetic compute workload generation and characterization process, in accordance with some examples described herein. In this example, a compute component may perform the process illustrated. In some examples, the compute component executing machine readable instructions may be compute component 100 or compute device 130 illustrated in FIG. 1.

At block 210, data may be received through a data collection process. The data may comprise real-world workload data received from one or more compute devices. In some examples, the workload data are collected via a management process located at the compute component that pulls the workload data from the compute device. The management process may comprise an Application Programming Interface (API) that pulls the workload data. In other examples, an agent or other software program that is installed on the compute device may transmit/push the workload data from the compute device to the compute component.

At block 220, a first machine learning model may generate synthetic workload data. For example, the real workload data may be received by the first machine learning model as input and output of the model may be the synthetic workload data. The synthetic workload data may align with a specific pattern that corresponds to the pattern of real workload data received from the compute device.

In some examples, the first machine learning model may include random noise or conditional input, similar to the real workload data. For example, the random noise may be sampled from a vector/embedding from a simple distribution, such as a Gaussian distribution (e.g., normal distribution) or Uniform distribution. In some examples, the synthetic workload data may mimic interrelations between components at the compute device. For example, the interrelations of components may include processes that access the CPU, memory, and I/O for a particular workload running on the compute device. The first machine learning model may generate synthetic workload data that mimics the pattern in the real workload data.

At block 230, the workload metrics may be aligned between the synthetic workload data and the real workload data when the amount of real workload data and synthetic workload data reaches a threshold amount. In this example, the CPU, memory, I/O, or other utilizations of the compute device identified in the real workload data may include ten days of real workload data that are aligned and illustrated in the synthetic workload data that spans more than ten days (e.g., twenty days).

The process illustrated at blocks 210-230 may help expand the dataset from the compute device or set of compute devices. For example, real workload data from a single compute device may be expanded to multiple compute devices. In another example, an initial set of compute devices may include one hundred compute devices or one hundred matrices of real datasets, and the synthetic workload data may grow the modeled compute devices to 100,000 or more. The pattern from the real workload data may be similar to the pattern generated in the synthetic workload data.

At block 240, the workload may be classified using a second machine learning model. For example, the combined synthetic workload data and real workload data may be provided to the second machine learning model as input. Output of the second machine learning model may include a classification of a specific compute workload type identified in the workload data.

At block 250, a configuration setting of the compute device can be adjusted. For example, the change in the configuration setting can reduce the power consumption of the device or, in some examples, adjust the execution process/mapping of the CPU. In some examples, the change in the configuration setting is an adjustment to a virtualization-specific workload.

At block 260, the performance of the compute device can be monitored by receiving/collecting additional/second real workload data after the system configuration setting is adjusted. For example, the real workload data may be pulled from the compute device, as discussed with block 210, and provided as input to the first machine learning model to generate synthetic workload data, as discussed with block 220.

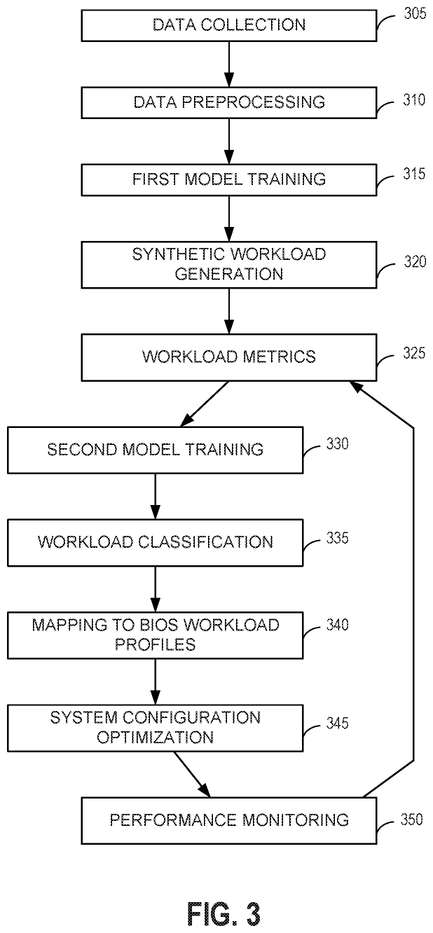

FIG. 3 illustrates a synthetic compute workload generation and characterization process, in accordance with some examples described herein. In this example, a compute component may perform the process illustrated. In some examples, the compute component executing machine readable instructions may be compute component 100 or compute device 130 illustrated in FIG. 1.

At block 305, data may be received through a data collection process. The data may comprise real-world workload data received from one or more compute devices. In some examples, the workload data are collected via a management process located at the compute component that pulls the workload data from the compute device. The management process may comprise an Application Programming Interface (API) that pulls the workload data. In other examples, an agent or other software program that is installed on the compute device may transmit/push the workload data from the compute device to the compute component.

At block 310, data may be pre-processed. The pre-processing may clean the received workload data from the compute device. The pre-processing may remove noises, handle missing values in the workload data, standardize formatting, and the like. In some examples, the pre-processing may prepare the workload data for input to additional processing by the machine learning model.

In some examples, the pre-processing may include normalization of the workload data, which can help standardize the workload data for input to a machine learning model (e.g., the cGAN model). The normalization may correspond to the formula:

$${X}_{normalized} = ( X - {X}_{min} ) / ( {X}_{max} - {X}_{min} ) .$$

At block 315, the first machine learning model may be trained, including a cGAN model, in some examples. For example, the computing component may create a cGAN model that comprises generator and discriminator networks that are trained to generate synthetic workload data based on the real workload data. The two models may be executed to generate synthetic data (by the generator) and pass off the generated data as real data (by the discriminator). The two models may be updated dynamically as part of the cGAN model to learn in an unsupervised manner.

The cGAN model may receive the pre-processed workload data that has been normalized. The pre-processed workload data may be input to the cGAN model to generate the synthetic workload data.

At block 320, the cGAN model may generate synthetic workload data. For example, the pre-processed workload data may be received by the cGAN model as input and output of the model may be the synthetic workload data. The generator can receive both real and synthetic workload data and the discriminator can determine the authenticity of the generated synthetic workload data. As training progresses, the synthetic workload data may align with a specific pattern that corresponds to the pattern of workload data received from the compute device. The cGAN model may be defined as:

$$cGAN model = G ( z , X ) = Dense Layers \to Synthetic Data \\ Discriminator = D ( X , G ( z , X ) ) \\ Loss Functions = LG = - log ( D ( G ( z , X ) ) ) \\ Discriminator Loss = LD = - [ log ( D ( X ) ) + log ( 1 - D ( G ( z , X ) ) ) ]$$

In some examples, the cGAN model may include random noise or conditional input, similar to the real workload data. For example, the random noise may be sampled from a vector/embedding from a simple distribution, such as a Gaussian distribution (e.g., normal distribution) or Uniform distribution. In some examples, conditional information is also provided to the generator and discriminator in addition to the random noise. This condition may correspond with a label (e.g., workload data type or class information) or some other context that guides the generation process. The condition may be combined with the random noise in various ways, such as by concatenating it with the noise vector or by conditioning layers in the network. This conditioning can allow the generator to create specific outputs, such as generating synthetic workload data of a particular type (e.g., CPU, memory, or I/O) based on the provided label.

In some examples, the synthetic workload data may mimic interrelations between components at the compute device. For example, the interrelations of components may include processes that access the CPU, memory, and I/O for a particular workload running on the compute device. The cGAN network may generate synthetic workload data that mimics the pattern in the real workload data.

At block 325, the workload metrics may be aligned between the synthetic workload data and the real workload data when the amount of real workload data and synthetic workload data reaches a threshold amount. In this example, the CPU, memory, I/O, or other utilizations of the compute device identified in the real workload data may include ten days of real workload data that are aligned and illustrated in the synthetic workload data that spans more than ten days (e.g., twenty days).

In some examples, the workload classification by the second machine learning model may be analyzed and, based on the analysis, a process can be initiated to receive additional real workload data. The additional real workload data may be used to generate additional synthetic workload data to increase the amount of workload data to the threshold amount.

As an illustrative example, the classification of the real workload data and synthetic workload data may be analyzed for accuracy of the workload classification. The model drift related to the model hyperparameter of the second machine learning model may be determined. The model hyperparameter may be tuned or retuned based on the classification accuracy. When the hyper parameter does not exceed an accuracy threshold, additional synthetic workload data may be generated or, in some examples, additional real workload data may be received in order to generate more/different synthetic workload data. The new real workload data may include existing devices in the environment or new devices, each of which may be included in the real workload data.

In some examples, the utilization metrics may be compared between the real workload data and the synthetic workload data using a MSE. The MSE between real workload data and the synthetic workload data may measure the difference between the two data values and quantify the average squared differences between the two datasets. For example, the MSE formula may be:

$$MSE = \frac{1}{n} {\sum }_{i = 1}^{n} {( {y}_{i} - {\hat{y}}_{i} )}^{2}$$

Where n is the total number of data points, yᵢ is the real workload data for the i-th sample, and ŷᵢ is the synthetic workload data for the i-th sample. The relatively lower MSE may indicate that the synthetic workload data is closer to the real workload data, i.e., the model's predictions are more accurate, and the relatively higher MSE may indicate a larger discrepancy between the values and poor model performance.

The process illustrated at blocks 305-325 may help expand the dataset from the compute device or set of compute devices. For example, real workload data from a single compute device may be expanded to multiple compute devices. In another example, an initial set of compute devices may include one hundred compute devices or one hundred matrices of real datasets, and the synthetic workload data may grow the modeled compute devices to 100,000 or more. The pattern from the real workload data may be similar to the pattern generated in the synthetic workload data.

At block 330, a second machine learning model may be trained, including an LSTM model in some examples, to classify the new workload pattern in the synthetic workload data. Since the synthetic workload data is generated and provided as input to the LSTM model, the input may correspond with a pattern over a longer time range. The pattern may identify a trend over different time metrics. The data trend may be used to train the LSTM to classify the workload data in the context of a specific compute workload type or a specific pattern like CPU-bound or memory-bound.

The workload may be associated with a utilization value of the compute workload type. In some examples, the utilization value is stored as a percentage of the total maximum sustained workload that is available. The utilization value may correspond with zero when the component is unused and one hundred percent when the component is used to its full capacity. In these examples, increased utilization may not be available when the component is utilized at its full capacity. As an illustrative example, a processor may run at a highest individual core speed and increased throughput may not occur when the processor is able to perform sustained work across all available cores during maximum utilization. In another example, a power management configuration setting may be disabled when the adjustment would have impact on maximum achievable workload capacity.

In some examples, the utilization value may be used to assign a label to the workload data. The label may be assigned to the workload data during the classification process to correspond with the dominate workload type or characteristic. As an illustration, the workload data may be labeled “CPU-Intensive” if CPU utilization >80% (e.g., 80% of full workload capacity), labeled “Memory-Intensive” if memory utilization >80% (e.g., 80% of full memory capacity), labeled “I/O-Intensive” if I/O utilization >80% (e.g., 80% of full throughput), and labeled “Balanced” if no utilization metric dominates (e.g., same utilization values for different workload types or characteristics, values within a percentage/range). The LSTM model may classify the synthetic workload data into distinct categories.

At block 235, the workload may be classified using the LSTM model. For example, the combined synthetic workload data and real workload data may be provided to the LSTM as input and output of the LSTM model may include a classification of a specific compute workload type identified in the workload data.

At block 340, the workload may be mapped to a BIOS workload profile. The mapping corresponds with a particular BIOS settings, including a clock speed, CPU executions, initiated tasks that affect the power consumption, and so on. In some examples, the BIOS profile may include high performance computing.

At block 345, the BIOS workload profile can identify and adjust the system configuration setting of the compute device. For example, the change in the BIOS workload can reduce the power consumption of the device or, in some examples, adjust the execution process/mapping of the CPU. In some examples, the change in the configuration of the compute device is an adjustment to a virtualization-specific workload.

At block 350, the performance of the compute device can be monitored by receiving/collecting additional/second real workload data after the system configuration setting is adjusted. For example, the real workload data may be pulled from the compute device, as discussed with block 305, and processed, as discussed with block 310.

In some examples, the LSTM model may be retrained in response to the second real workload data from the compute device. The retraining process may classify the new workload pattern in the second real workload data. In some examples, the retraining process may be continuously initiated as new workload data is received from the compute device.

During the retraining process, additional synthetic data may not be generated. For example, the first real workload data may be generated from the compute device and the synthetic workload data may be generated from the first real world data, both of which are provided to the LSTM model to initially train it. When the second real workload data are received, the LSTM model may have a sufficient amount of data to perform the classification process and accurately identify workload data type/label.

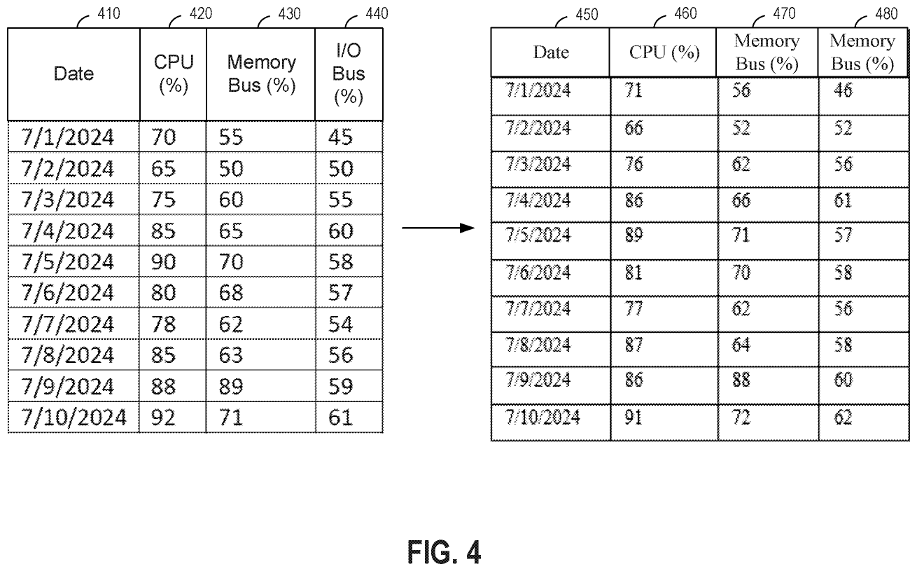

FIG. 4 illustrates real workload data and synthetic workload data, in accordance with some examples described herein. In some examples, the cGAN model executed by a compute component executing machine readable instructions to receive real workload data and generate the synthetic workload data. The compute component executing machine readable instructions may be compute component 100 or compute device 130 illustrated in FIG. 1.

In this example, the real workload data is received for ten days. The real workload data comprises date 410, workload data tasks that are CPU-bound 420, workload data tasks that are memory bus-bound 430, and workload data tasks that are I/O bus-bound 440. The real workload data may be received from a compute device in a data center, where utilization targets are established based on the specific needs of the workloads or compute devices in the environment.

The real workload data may be provided to the cGAN model to generate synthetic workload data and classify the data using the LSTM model, as discussed throughout the disclosure. The models may be trained alternately, minimizing the generator and discriminator losses over multiple epochs. The generator and discriminator were trained alternately, using binary cross-entropy loss to refine their performance and trained generator produced synthetic workloads that mimicked the patterns of the real data. Once trained, the generator can generate synthetic workload data that closely follows the patterns of the real data. In this example, the synthetic workload data includes similar values as the real workload data, including date 450, synthetic values for workload data tasks that are CPU-bound 460, synthetic values for workload data tasks that are memory bus-bound 470, and synthetic values for workload data tasks that are I/O bus-bound 480.

When the real and synthetic workload data are compared, the MSE may be generated for each utilization metric. For example, the calculated MSE values are CPU Utilization: 0.00137, Memory Utilization: 0.00227, I/O Utilization: 0.00391. These low MSE values indicate that the synthetic workload data closely approximates the real workload data, demonstrating that the cGAN effectively captured the underlying patterns of the workloads at the compute device.

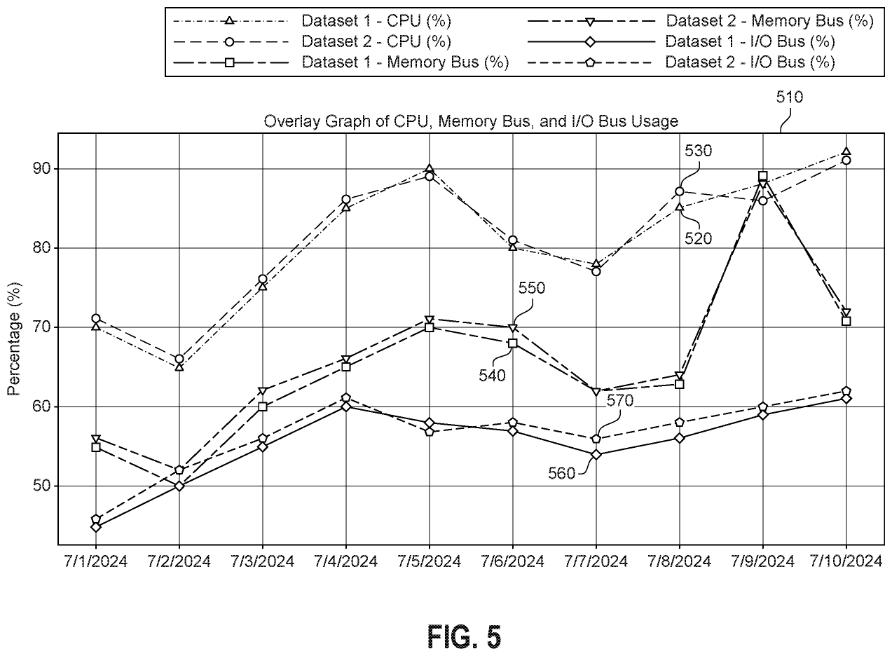

FIG. 5 illustrates an overlay graph of real workload data and synthetic workload data, in accordance with some examples described herein. The compute component executing machine readable instructions may be compute component 100 or compute device 130 illustrated in FIG. 1.

In some examples, the overlay graph can illustrate how the first machine learning model (e.g., the cGAN model) can accurately generate the synthetic workload data that approximates or mimics the real workload data for the compute device. The synthetic workload data can be combined with the real workload data to create a sufficient amount of workload data to accurately train the second machine learning model (e.g., the LSTM model). The sufficient amount of data can be reached absent having real workload data by using the synthetic workload data.

In chart 510, the cGAN model executed by a compute component may execute machine readable instructions to receive real workload data and generate the synthetic workload data. The real workload data and synthetic workload data may be mapped in a chart that identifies the workload progression across a time series. In this example, the cGAN model is trained for a specific workload and identifying the real workload data along the time series. The data mapped to the time series illustrates the likely outcomes of the workloads based on the real data inputs.

In a first example, real workload data 520 and synthetic workload data 530 correspond with a CPU workload of a compute device along a time series. For example, as shown in FIG. 4, the time series corresponds with ten days with real workload data for CPU-bound tasks shown in column 420 and the synthetic workload data for CPU-bound tasks shown in column 460. When the real and synthetic workload data are compared, the calculated MSE value for CPU Utilization is 0.00137, indicating that the synthetic workload data closely approximates the real workload data for these types of tasks.

In a second example, real workload data 540 and synthetic workload data 550 correspond with a memory bus workload of a compute device along a time series. For example, as shown in FIG. 4, the time series corresponds with ten days with real workload data for memory bus-bound tasks shown in column 430 and the synthetic workload data for memory bus-bound tasks shown in column 470. When the real and synthetic workload data are compared, the calculated MSE value for memory utilization is 0.00227, indicating that the synthetic workload data closely approximates the real workload data for these types of tasks.

In a third example, real workload data 560 and synthetic workload data 570 correspond with an I/O bus workload of a compute device along a time series. For example, as shown in FIG. 4, the time series corresponds with ten days with real workload data for I/O-bound tasks shown in column 440 and the synthetic workload data for I/O-bound tasks shown in column 480. When the real and synthetic workload data are compared, the calculated MSE value for I/O utilization is 0.00391, indicating that the synthetic workload data closely approximates the real workload data for these types of tasks.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

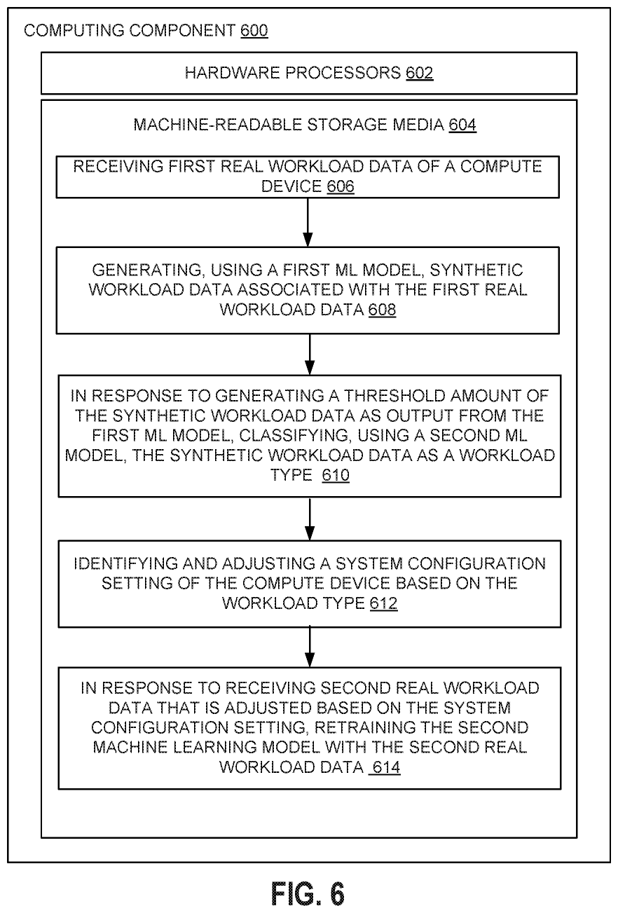

FIG. 6 illustrates a computing component that may be used to implement AI based synthetic compute workload generation and characterization, in accordance with various examples of the disclosed technology. In this example, computing component 600 may be, for example, a server computer, a controller, or any other similar computing component capable of processing data. In the example implementation of FIG. 6, the computing component 600 includes hardware processor 602 and machine-readable storage medium 604.

Hardware processor 602 may be one or more central processing units (CPUs), graphics processing units (GPUs), semiconductor-based microprocessors, and/or other hardware devices suitable for retrieval and execution of instructions stored in machine-readable storage medium 604. Hardware processor 602 may fetch, decode, and execute instructions, such as instructions 606-614, to control processes or operations for AI based synthetic compute workload generation and characterization. As an alternative or in addition to retrieving and executing instructions, hardware processor 602 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 604, may be any electronic, magnetic, optical, or other physical storage device that contains or stores executable instructions. Thus, machine-readable storage medium 604 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 604 may be a non-transitory storage medium, where the term “non-transitory” does not encompass transitory propagating signals. As described in detail below, machine-readable storage medium 604 may be encoded with executable instructions, for example, instructions 606-614.

Hardware processor 602 may execute instruction 606 to receive first real workload data of a compute device. For example, the real workload data may correspond with machine-readable instruction-based computational tasks that are executed or performed by the compute device. The real workload data may be generated when the computational task is initiated or executed (e.g., GPU- or CPU-bound, memory-bound, and I/O-bound tasks). The computational tasks may affect the state of the compute device, which can be detected in the workload data.

In some examples, the real workload data may comprise operational characteristics and parameters of the compute device. For example, the real workload data may comprise different types of integrations like memory bus integrations, Graphics Processing Unit (GPU) bus integrations, Central Processing Unit (CPU) bus integrations, or input/output (I/O) bus integrations. Integrations may correspond with workloads at the compute device, including memory workloads, power workloads, processor workloads, and so on. In some examples, real workload data may comprise temperature, humidity, or other sensor-detected values in an environment.

Hardware processor 602 may execute instruction 608 to generate synthetic workload data associated with the first real workload data. The synthetic workload data may be generated by a first machine learning model.

In some examples, the first machine learning model may correspond with a cGAN model configured with a generator neural network and discriminator neural network that are trained to generate the synthetic workload data. The generator may generate candidate synthetic workload data while the discriminator may determine how realistic the generated input seems. The generator can learn to map from a latent space to a data distribution of interest, while the discriminator distinguishes candidates produced by the generator from the true data distribution.

In some examples, the generator is seeded with randomized input that is sampled from a predefined latent space (e.g. a multivariate normal distribution). The candidates may be generated/synthesized by the generator and evaluated by the discriminator. Independent back-propagation procedures may be applied to both networks so that the generator produces better candidate synthetic workload data, while the discriminator learns to flag the synthetic workload data. In some examples, the generator is a dCNN and the discriminator is a CNN.

The synthetic workload data may include random noise or conditional input. The random noise may be sampled from a vector/embedding from a simple distribution, such as a Gaussian distribution (e.g., normal distribution) or Uniform distribution. In some examples, conditional information is also provided to the generator and discriminator in addition to the random noise. This condition may correspond with a label (e.g., workload data type or class information) or some other context that guides the generation process. The condition may be combined with the random noise in various ways, such as by concatenating it with the noise vector or by conditioning layers in the network. This conditioning can allow the generator to create specific outputs, such as generating synthetic workload data of a particular type (e.g., CPU, memory, or I/O) based on the provided label.

Hardware processor 602 may execute instruction 610 to classify the synthetic workload data as a compute workload type or a specific pattern like CPU-bound or memory-bound. The classification may be generated by a second machine learning model (e.g., an LSTM model).

The classification may determine the context/type of workload that is running on the compute (e.g., based on server matrices). For example, the second machine learning model may be trained to compute the hidden states (“h_t”) and cell states (“c_t”) at each time step “t”. The Forget Gate may determine what information to discard from the cell state.

$${f}_{t} = σ ( {W}_{f} \cdot [ {h}_{t - 1} , {x}_{t} ) + {b}_{f} \\ Input Gate : Decides which values to update . \\ {i}_{t} = σ ( {W}_{i} \cdot [ {h}_{t - 1} , {x}_{t} ) + {b}_{i} \\ {C}_{t}^{∼} = tanh ( {W}_{c} \cdot [ {h}_{t - 1} , {x}_{t} ) + {b}_{C} \\ Output Gate for next hidden state : \\ {o}_{t} = σ ( {W}_{o} \cdot [ {h}_{t - 1} , {x}_{t} ) + {b}_{o} \\ {h}_{t} = {o}_{t} * tanh ( {C}_{t )}$$

After processing the entire sequence, the final output may be passed through a dense layer for classification. The label assigned to the combined real/synthetic workload data during the classification process may correspond with the dominate workload type or characteristic.

The classification may be generated in response to generating a threshold amount of the synthetic workload data as output from the first machine learning model. The threshold amount of workload data may vary by implementation. For example, the threshold amount of real workload data may include ten days of real workload data that are aligned and illustrated in the synthetic workload data that spans more than ten days (e.g., twenty days). In other examples, the threshold amount of real workload data may include one year of data. This duration of workload data may include seasonality or repeating patterns in a significant amount of real workload data. The inclusion of the repeating patterns in the real workload data may help train the first machine learning model to generate synthetic workload data with similar features throughout a reasonable duration of time.

Hardware processor 602 may execute instruction 612 to identify and adjust a system configuration setting of the compute device based on the compute workload type. The system configuration setting may correspond with a particular BIOS settings in a BIOS workload profile. The settings may include a clock speed, CPU executions, initiated tasks that affect the power consumption, and so on. In some examples, the BIOS profile may include high performance computing.

The adjustment to the setting can change the operations at the compute device. For example, by adjusting the BIOS workload setting, the power consumption can be reduced at the compute device. In another example, the adjustment to the setting can affect the execution process/mapping of the CPU of the compute device. In some examples, the change in the configuration of the compute device is an adjustment to a virtualization-specific workload.

Hardware processor 602 may execute instruction 614 to retrain the second machine learning model with the second real workload data. The retraining may be initiated in response to receiving the second real workload data that is adjusted based on the system configuration setting. For example, in response to adjusting the setting, additional real workload data may be received. The second machine learning model can be retrained to adjust the classification of the new workload pattern in the second real workload data. In some examples, the retraining process may be continuously initiated as new workload data is received from the compute device.

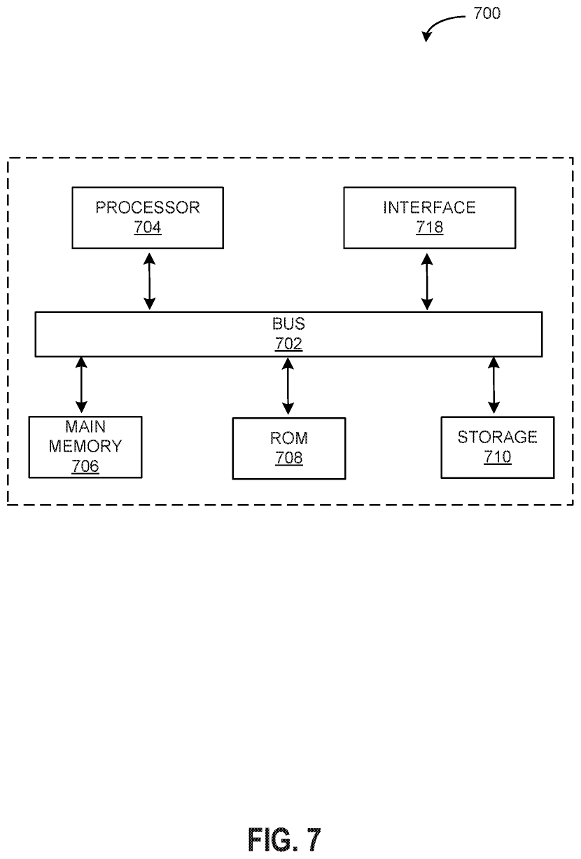

FIG. 7 depicts a block diagram of an example computer system 700 in which various examples of the disclosed technology described herein may be implemented. Computer system 700 includes bus 702 or other communication mechanism for communicating information, one or more hardware processors 704 coupled with bus 702 for processing information. Hardware processor(s) 704 may be, for example, one or more general purpose microprocessors.

Computer system 700 also includes main memory 706, such as a random access memory (RAM), cache and/or other dynamic storage devices, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions.

Computer system 700 further includes read only memory (ROM) 708 or other static storage device coupled to bus 702 for storing static information and instructions for processor 704. Storage device 710, such as a magnetic disk, optical disk, or USB thumb drive (Flash drive), etc., is provided and coupled to bus 702 for storing information and instructions.

Computer system 700 may include a user interface module to implement a GUI to provide to display. The user interface module may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

Computer system 700 may implement the techniques described herein using customized hard-wired logic, one or more ASICs or FPGAs, firmware and/or program logic which in combination with the computer system causes or programs computer system 700 to be a special-purpose machine. According to one example of the disclosed technology, the techniques herein are performed by computer system 700 in response to processor(s) 704 executing one or more sequences of one or more instructions contained in main memory 706. Such instructions may be read into main memory 706 from another storage medium, such as storage device 710. Execution of the sequences of instructions contained in main memory 706 causes processor(s) 704 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 710. Volatile media includes dynamic memory, such as main memory 706. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 702. Transmission media can also take the form of acoustic or light waves, such as those generated during radio-wave and infra-red data communications.

Computer system 700 also includes interface 718 coupled to bus 702. Interface 718 provides a two-way data communication coupling to one or more network links that are connected to one or more local networks. For example, interface 718 may be an integrated services digital network (ISDN) card, cable modem, satellite modem, or a modem to provide a data communication connection to a corresponding type of telephone line. As another example, interface 718 may be a local area network (LAN) card to provide a data communication connection to a compatible LAN (or WAN component to communicate with a WAN). Wireless links may also be implemented. In any such implementation, interface 718 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through interface 718, which carry the digital data to and from computer system 700, are example forms of transmission media.

Computer system 700 can send messages and receive data, including program code, through the network(s), network link and interface 718. In the Internet example, a server might transmit a requested code for an application program through the Internet, the ISP, the local network and interface 718.

The received code may be executed by processor 704 as it is received, and/or stored in storage device 710, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAS, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 700.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A computer-implemented method comprising:
receiving first real workload data of a compute device;
generating, using a first machine learning model, synthetic workload data associated with the first real workload data that includes random noise or conditional input;
in response to generating a threshold amount of the synthetic workload data as output from the first machine learning model, classifying, using a second machine learning model, the synthetic workload data as a workload type;
identifying and adjusting a system configuration setting of the compute device based on the workload type; and
in response to receiving second real workload data that is adjusted based on the system configuration setting, retraining the second machine learning model with the second real workload data.

2. The method of claim 1, wherein the first machine learning model is a conditional Generative Adversarial Network (cGAN).

3. The method of claim 1, further comprising:
in response to the classification of the synthetic workload data, enabling an assignment of a Basic Input/Output System (BIOS) workload profile for the compute device, wherein the BIOS workload profile optimizes system configurations for specific CPU-bound, memory-bound, and I/O-bound tasks.

4. The method of claim 1, wherein the first real workload data of the compute device comprises CPU, memory, and I/O utilization, and the workload type comprises CPU-bound, memory-bound, and I/O-bound tasks.

5. The method of claim 1, wherein the first machine learning model is selected based on the workload type, and the first machine learning model is trained based on the first real workload data.

6. The method of claim 1, wherein the second machine learning model is a Long Short-Term Memory (LSTM) model.

7. The method of claim 1, further comprising:
quantifying the synthetic workload data generated by the first machine learning model using Mean Squared Error (MSE) with a formula comprising:
$$MSE = \frac{1}{n} {\sum }_{i = 1}^{n} {( {y}_{i} - {\hat{y}}_{i} )}^{2}$$
where n is a total number of data points, yᵢ is the first real workload data for the i-th sample, and ŷᵢ is the synthetic workload data for the i-th sample.

8. The method of claim 1, wherein the workload type is CPU bound, memory bound, or I/O bound tasks.

9. A compute component comprising:
a memory storing instructions; and
a processor communicatively coupled to the memory and configured to execute the instructions to:
receive first real workload data of a compute device associated with processor tasks of the compute device;
generate, using a first machine learning model, synthetic workload data associated with the first real workload data that includes random noise or conditional input;
in response to generating a threshold amount of the synthetic workload data as output from the first machine learning model, classify, using a second machine learning model, the synthetic workload data as being associated with the processor tasks of the compute device;
identify and adjust a system configuration setting of a processor of the compute device; and
in response to receiving second real workload data that is adjusted based on the system configuration setting, retrain the second machine learning model with the second real workload data.

10. The compute component of claim 9, wherein the first machine learning model is a conditional Generative Adversarial Network (cGAN).

11. The compute component of claim 9, wherein the processor is further configured to execute the instructions to:
enable an assignment of a Basic Input/Output System (BIOS) workload profile for the compute device, wherein the BIOS workload profile optimizes system configurations for specific CPU-bound, memory-bound, and I/O-bound tasks.

12. The compute component of claim 9, wherein the first real workload data of the compute device comprises CPU, memory, and I/O utilization, and the workload type comprises CPU-bound, memory-bound, and I/O-bound tasks.

13. The compute component of claim 9, wherein the first machine learning model is selected based on the workload type, and the first machine learning model is trained based on the first real workload data.

14. The compute component of claim 9, wherein the second machine learning model is a Long Short-Term Memory (LSTM) model.

15. The compute component of claim 9, wherein the processor is further configured to execute the instructions to:
quantify the synthetic workload data generated by the first machine learning model using Mean Squared Error (MSE) with a formula comprising:
$$MSE = \frac{1}{n} {\sum }_{i = 1}^{n} {( {y}_{i} - {\hat{y}}_{i} )}^{2}$$
where n is a tc number of data points, yᵢ is the first real workload data for the i-th sample, and is the synthetic workload data for the i-th sample.

16. The compute component of claim 9, wherein the workload type is CPU bound, memory bound, or I/O bound tasks.

17. A server comprising:
a memory storing instructions; and
a processor communicatively coupled to the memory and configured to execute the instructions to:
receive first real workload data of a compute device;
generate, using a conditional Generative Adversarial Network (cGAN) model, synthetic workload data associated with the first real workload data that includes random noise or conditional input;
in response to generating a threshold amount of the synthetic workload data as output from the cGAN model, classify, using a Long Short-Term Memory (LSTM) model, the synthetic workload data as a workload type;
identify and adjust a system configuration setting of the compute device based on the workload type; and
in response to receiving second real workload data that is adjusted based on the system configuration setting, retrain the LSTM model with the second real workload data.

18. The server of claim 17, wherein the processor is further configured to execute the instructions to:
enable an assignment of a Basic Input/Output System (BIOS) workload profile for the compute device, wherein the BIOS workload profile optimizes system configurations for specific CPU-bound, memory-bound, and I/O-bound tasks.

19. The server of claim 17, wherein the first real workload data of the compute device comprises CPU, memory, and I/O utilization, and the workload type comprises CPU-bound, memory-bound, and I/O-bound tasks.

20. The server of claim 17, wherein the processor is further configured to execute the instructions to:
quantify the synthetic workload data generated by the first machine learning model using Mean Squared Error (MSE) with a formula comprising:
$$MSE = \frac{1}{n} {\sum }_{i = 1}^{n} {( {y}_{i} - {\hat{y}}_{i} )}^{2}$$
where n is a total number of data points, yᵢ is the first real workload data for the i-th sample, and yᵢ is the synthetic workload data for the i-th sample.
